(19) United States
(12) Patent Application Publication
(10) Pub. No.: US 2008/0265834 A1
(43) Pub. Date: Oct. 30, 2008

(54) SOLAR-POWERED PHOTOELECTRIC APPARATUS

(75) Inventors: Cheng Ming Lin, Taipei City (TW); Jian Hung Lai, Taichung City (TW)

Correspondence Address: CONNOLLY BOVE LODGE & HUTZ LLP, 1875 EYE STREET, N.W., SUITE 1100, WASHINGTON, DC, 20006, US

(73) Assignee: ADVANCED ENERGY TECHNOLOGY CO., LTD., Taipei City (TW)

(21) Appl. No.: 12/105,793

(22) Filed: Apr. 18, 2008

(30) Foreign Application Priority Data
Apr. 25, 2007 (TW) 096206563

(51) Int. Cl. H02J 7/00

(52) U.S. Cl. 320/101

(57) ABSTRACT

A solar-powered photoelectric apparatus comprises a solar cell panel, a rechargeable battery and one or more photoelectric devices. The solar cell panel absorbs light to generate electricity and the electricity is stored in the photoelectric device. The photoelectric device uses power from the rechargeable battery to generate light. In consideration of times of insufficient light to the solar-powered photoelectric apparatus, the photoelectric apparatus may further comprise a USB connector as an interface for charging the rechargeable battery.

### BACKGROUND OF THE INVENTION

(A) Field of the Invention

The present invention is related to a photoelectric apparatus, and more particularly, to a solar-powered photoelectric apparatus.

(B) Description of the Related Art

Solar energy has many advantages, e.g., it is abundant, clean, safe, not monopolized by specific countries or people, does not create pollution, and can provide a stable supply of light and heat. As oil prices increase, solar energy becomes an alternative and is developed energetically.

A solar cell is made by the semiconductor process. When light illuminates a solar cell panel, the solar cell panel absorbs the lights and the p-type semiconductor and n-type semiconductor generate (negative) electrons and (positive) holes. The electrons and holes are separated to generate a voltage drop, which is transmitted to a load for use through a wire.

Because the solar cell generates direct current (DC) power, it is very suitable for use with electronic gadgets such as light emitting diode (LED) flashing lights, laser pointers and lamps of legal tender-checking apparatus. However, these small gadgets are commonly used indoors, where solar cell panels may not receive sufficient light. Therefore, the conserved electric power may be not sufficient to sustain the long-term use of the electronic gadgets.

### SUMMARY OF THE INVENTION

The present invention is directed to providing a solar-powered photoelectric apparatus. Clean, environmentally sound solar energy is used to generate power for a photoelectric device of the photoelectric apparatus. Moreover, in association with Universal Serial Bus (USB) charging technology, the photoelectric device can avoid insufficient electricity problems.

In accordance with the present invention, a solar-powered photoelectric apparatus comprises a solar cell panel, a rechargeable battery and one or more photoelectric devices. The solar cell panel absorbs light to generate electricity that is stored in the photoelectric device. The photoelectric device uses power from the rechargeable battery to generate lights. For instance, the photoelectric device may be a laser pointer, an LED lamp or a lamp for checking legal tender.

In consideration of periods when insufficient light shines on the solar-powered photoelectric apparatus, the photoelectric apparatus may further comprise a USB connector as an interface for charging the rechargeable battery.

The solar-powered photoelectric apparatus of the present invention can be charged for later use while there is sufficient light for charging. In addition to saving power, the solar-powered photoelectric apparatus meets the criteria of environmental protection.

### BRIEF DESCRIPTION OF THE DRAWINGS

FIG. 1 illustrates a photoelectric apparatus in accordance with an embodiment of the present invention; and

FIG. 2 illustrates a photoelectric apparatus in accordance with another embodiment of the present invention.

### DETAILED DESCRIPTION OF THE INVENTION

The present invention is explained with reference to drawings below, so as to clearly describe the features of the present invention.

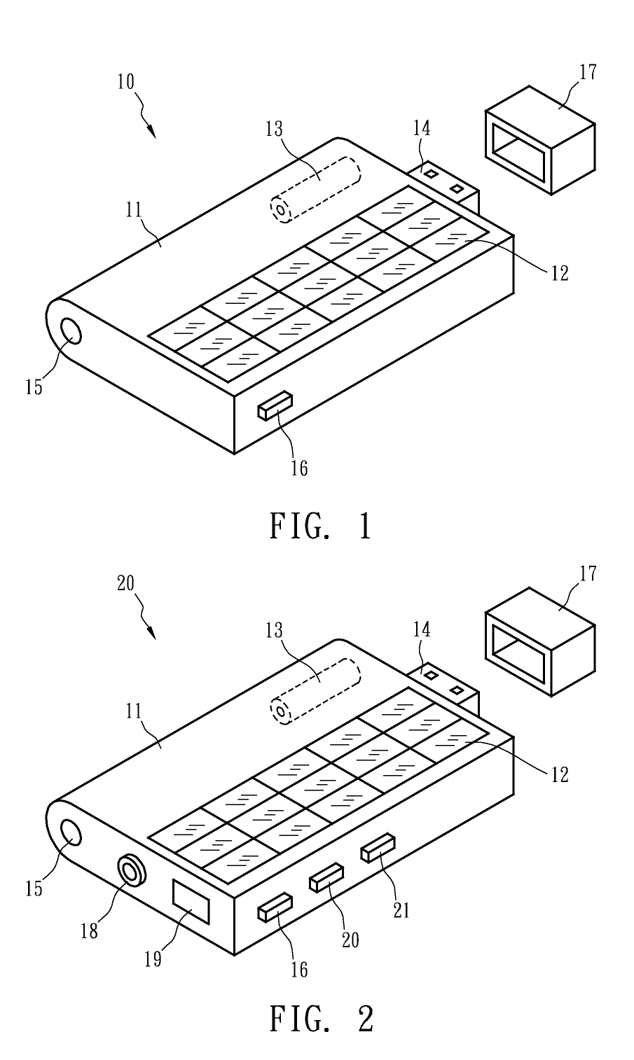

FIG. 1 illustrates a solar-powered photoelectric apparatus. The photoelectric apparatus 10 comprises a shell 11, a solar cell panel 12, a rechargeable battery 13, a USB connector 14 and a photoelectric device 15. In an embodiment, the photoelectric device 15 may be a laser pointer for presentations, an LED lamp or an LED lamp for checking legal tender. The solar cell panel 12 receives light and generates electricity that is stored in the rechargeable battery 13 in the shell 11. The rechargeable battery 13 may be nickel metal hydride (Ni-MH) or lithium batteries. The on/off of the photoelectric device 15 is controlled by a switch 16, and the power source of the photoelectric device 15 is provided by the rechargeable battery 13.

In some cases the photoelectric apparatus 10 is used indoors, for example, in an office, so it may not receive enough light. Therefore, a USB connector 14 is further provided as an interface for charging the rechargeable battery 13. If the solar cell panel 12 cannot generate sufficient electric power, the photoelectric apparatus 10 can be inserted into an electronic system, e.g., a computer, having a corresponding USB socket through the USB connector 14 so as to charge the rechargeable battery 13. The USB connector 14 may be protected by a cap 17 while not in use. In practice, the USB connector 14 can be of a bending type or a hiding type, so that the cap 17 can be omitted.

In FIG. 2, a solar-powered photoelectric apparatus 20 may be provided with many photoelectric devices 15, 18 and 19, which are controlled by switches 16, 20 and 21, respectively, thereby providing a multifunction apparatus. In this embodiment, the photoelectric device 15 is a laser pointer; the photoelectric device 18 is an LED lamp for illumination; the photoelectric device 19 is a lamp for checking legal tender. In addition to the photoelectric devices mentioned above, other photoelectric devices are covered by the scope of the present invention as well.

The above-described embodiments of the present invention are intended to be illustrative only. Numerous alternative embodiments may be devised by those skilled in the art without departing from the scope of the following claims.

What is claimed is:

1. A solar-powered photoelectric apparatus, comprising:
a solar cell panel absorbing light to generate electricity;
a rechargeable battery storing the electricity; and
at least one photoelectric device using power from the rechargeable battery to generate light.

2. The solar-powered photoelectric apparatus in accordance with claim 1, further comprising a universal serial bus (USB) connector electrically coupled to the rechargeable battery and configured to charge the rechargeable battery.

3. The solar-powered photoelectric apparatus in accordance with claim 2, wherein the USB connector is protected by a cap while the rechargeable battery is not being charged.

4. The solar-powered photoelectric apparatus in accordance with claim 1, wherein the rechargeable battery is placed in a shell, and the solar cell panel and the photoelectric device is placed on a surface of the shell.

5. The solar-powered photoelectric apparatus in accordance with claim 1, wherein the rechargeable battery is a nickel metal hydride battery or a lithium battery.

6. The solar-powered photoelectric apparatus in accordance with claim 1, wherein the photoelectric device is selected from the group consisting of a laser pointer, an LED lamp and a lamp for checking legal tender.

7. The solar-powered photoelectric apparatus in accordance with claim 1, wherein the photoelectric device is controlled by a switch.
